(19) United States
(12) Patent Application Publication
(10) Pub. No.: US 2022/0272948 A1
(43) Pub. Date: Sep. 1, 2022

(54) WEARABLE ELECTRONIC COLLAR FOR ANIMALS

(71) Applicant: GALLAGHER ESHEPHERD PTY LTD, Camberwell (AU)

(72) Inventors: Hugo BLANC, Eveleigh (AU); Libby CHRISTMAS, North Melbourne (AU); Sally HAYNES, Camberwell (AU); Marcus KRIGSMAN, North Melbourne (AU); Chris LEIGH-LANCASTER, Camberwell (AU); Stephen MORRIS, Camberwell (AU); Yassaman POULADI, Eveleigh (AU); Ian REILLY, Camberwell (AU); Ian SOHN, Camberwell (AU); Andrew ZIPSIN, Camberwell (AU)

(73) Assignee: GALLAGHER ESHEPHERD PTY LTD, Camberwell (AU)

(21) Appl. No.: 17/664,526

(22) Filed: May 23, 2022

Related U.S. Application Data
(63) Continuation-in-part of application No. PCT/AU2020/050537, filed on May 28, 2020.

(30) Foreign Application Priority Data
Nov. 22, 2019 (AU) 2019904412
Aug. 25, 2021 (AU) 2021221672

(51) Int. Cl. A01K 27/00; H02J 7/35

(52) U.S. Cl. CPC A01K 27/009; H02J 7/35

(57) ABSTRACT

An animal control unit comprising: a housing comprising at least two electrodes and an electronics module configured to controllably deliver an electrical stimulus to an animal wearing the animal control unit via said at least two electrodes, wherein the housing is shaped such that it rests on the upper side of the animal's neck when in use; a collar to which the housing is attached, the collar being configured for fitment around a neck of the animal to moveably retain the housing in a first position; and a biasing means configured to provide a self-righting force such that the housing is biased towards the first position during movement, and wherein at least one of said electrodes is a strip electrode comprising a strip portion shaped to rest along a natural contour of the animal's neck.

### CROSS REFERENCE TO RELATED APPLICATIONS

This application is a continuation-in-part of International Application No. PCT/AU2020/050537, filed on May 28, 2020, and published on Feb. 4, 2021 as WO 2021/016653, which claims priority to Australian Application No. 2019904412, filed Nov. 22, 2019 and also claims priority to Australian Application No. 2021221672, filed on Aug. 25, 2021. The entire contents of each application are incorporated herein by reference in their entireties.

### FIELD OF THE INVENTION

The invention generally relates to wearable electronic collars for animals, such as but not necessarily limited to livestock such as cattle.

### BACKGROUND TO THE INVENTION

In an existing system a virtual fencing system uses battery powered collar units (in some cases supplemented by solar power) attached to the necks of animals (e.g. cattle) to provide aversive and/or non-aversive stimuli to the animal based on its GPS location. The stimuli prevent the individual animals moving into particular pre-defined areas of a field or pasture, thereby establishing virtual boundaries that the animals will not or are unlikely to cross.

### SUMMARY OF THE INVENTION

An embodiment provides an animal control unit comprising: a housing comprising at least two electrodes and an electronics module configured to controllably deliver an electrical stimulus to an animal wearing the animal control unit via said at least two electrodes, wherein the housing is shaped such that it rests on the upper side of the animal's neck when in use; a collar to which the housing is attached, the collar being configured for fitment around a neck of the animal to moveably retain the housing in a first position; and a biasing means configured to provide a self-righting force such that the housing is biased towards the first position during movement, and wherein at least one of said electrodes is a strip electrode comprising a strip portion shaped to rest along a natural contour of the animal's neck.

For example, the biasing means may comprise a counterweight disposed along a length of the collar which may be configured to impart a self-righting force thereon, such that the housing may be biased towards the first position during movement of the animal. The counterweight may be substantially centrally located with respect to the collar.

An embodiment provides an animal control unit comprising: an electronics module configured to deliver a stimulus to an animal; a collar to which the electronics module is attached, with the collar being configured for fitment around a neck of an animal to moveably retain the electronics module in a first position; and a counterweight disposed along a length of the collar and configured to impart a self-righting force thereon, such that the electronics module is biased towards the first position during movement of the animal; wherein the counterweight is adapted to have restrained movement in a longitudinal direction along a length of the animal during movement thereof, to thereby reduce a tendency of the counterweight to physically impact the animal. Optionally, the counterweight may also be adapted to have restrained movement in a lateral direction across a width of the animal during movement thereof.

The counterweight may have a mass sufficiently greater than that of the electronics module in order to provide a self-righting force to the animal control unit. The counterweight may have a mass at least 1.2, and optionally 1.5, times that of the electronics module.

In some embodiments, the counterweight may include a first weight that is distributed along a length of the collar. The first weight may be integrally formed with the collar. Alternatively, the first weight may be attached to the collar. The first weight may be shaped to conform to an underside of the neck of the animal.

Additionally, the counterweight may also include a second weight that is located substantially centrally along a length of the collar, opposite the electronics module. The second weight may be a metal medallion, which may have a spherical, elliptical, cylindrical, or other suitable shape. Alternatively, the second weight may comprise a bag accommodating at least one of pellet-like forms or granular forms.

When in the first position, the electronics module may be located substantially atop a neck of the animal. For example, in the first position, a substantially central portion of the housing may be located substantially at a top position on the neck of the animal. The components of the electronics module may be contained within a housing, wherein the housing is preferably shaped to conform to an upper side of the animal's neck. The electronics module may include a solar powered electricity generator configured to power the animal control unit.

In some embodiments, the collar comprises at least one strap, the at least one strap having a width configured to distribute the first weight along a partial length of the neck of the animal. The collar may have an adjustable length. The collar may include a buckle configured to adjust the length of the collar. The buckle may be configured to self-release upon application of a force exceeding a release threshold force.

The electronics module may be configured to deliver the stimulus to the animal in response to the animal moving within a predetermined range of a predefined boundary. The stimulus may comprise an audible stimulus delivered by an exciter located within the housing. Alternatively, or additionally, the stimulus may comprise an electrical stimulus delivered to the animal via a pair of electrodes.

Described herein is an animal control unit comprising a collar, an electronics module and a biasing means; opposing ends of the collar attachable to the electronics module, the electronics module including at least two electrodes and having a housing, the housing incorporating a solar powered electricity generator, the biasing means disposed along the length of the collar; wherein the animal control unit is configured to selectively deliver an electrical stimulus to an animal wearing the collar via the electrodes.

Also described herein is an animal control unit comprising a collar and an electronics module; opposing ends of the collar attachable to the electronics module, the electronics module having a housing incorporating a solar powered electrical generator and at least two electrodes, wherein the animal control unit is configured to selectively deliver an electrical stimulus to an animal wearing the collar via the electrodes, and wherein at least one electrode is a strip electrode.

In some embodiments, the solar powered electrical generator may comprise one or more solar cells. The one or more solar cells may be disposed on one or more slanted surfaces, wherein each slanted surface has a selected slant angle. The one or more slanted surfaces may have slant angles selected such as to maximise, or at least substantially maximise, an average received solar irradiation. The average received solar irradiation may be estimated based on at least one of: an expected latitude of use of the animal control unit; a modelled behaviour of the animal; a number of solar cells; and a slant angle associated with the solar cells.

In some embodiments, the housing may be shaped such that it rests on the upper side of the animal's neck when in use. At least one of the electrodes may be a strip electrode. At least one of the electrodes may be shaped to rest along natural contour of the animal's neck. The housing may further comprise an audible stimulus generator, and wherein the electronics module is configured to selectively apply an audible stimulus via the audible stimulus generator. The audible stimulus generator may comprise an exciter coupled to an interior surface of the housing.

In some embodiments, the biasing means may be a counterweight. The counterweight may be substantially centrally located with respect to the collar. The biasing means may be configured to provide a self-righting force such that the housing is biased towards a position atop the neck of the animal during movement. The counterweight may have a mass greater than the mass of the electronics module. Preferably the counterweight may have a mass at least 1.2 times the mass of the electronics module. More preferably, the counterweight may have a mass at least 1.5 times the mass of the electronics module.

In some embodiments, the collar may comprise a plurality of elongate straps. The collar may include a buckle configured to receive at least 2 of the plurality of elongate straps. The buckle may include a friction means.

The friction means may engage with at least one of the plurality of elongate straps to restrict movement of the strap(s) relative to the buckle. The friction means may be protruding teeth. The buckle may be configured to operate as a ratchet. The buckle may be configured to self-release upon application of a force exceeding a release threshold force. The release threshold force may be approximately 100 kgf. The collar may have an adjustable length.

Also described herein is a method including fitting a collar according to a previous aspect to an animal. The method may include the step of fitting the collar to a neck of an animal. The method may include fitting the collar with sufficient play to enable a self-righting force due to the biasing means and to allow movement of the electronics module with respect to the skin of the animal.

As used herein, the word “comprise” or variations such as “comprises” or “comprising” is used in an inclusive sense, i.e. to specify the presence of the stated features but not to preclude the presence or addition of further features in various embodiments of the invention.

### BRIEF DESCRIPTION OF THE DRAWINGS

In order that the invention may be more clearly understood, embodiments will now be described, by way of example, with reference to the accompanying drawing, in which:

FIG. 1 is a perspective view of an animal control unit, according to one embodiment of the invention.

FIG. 2A is a top perspective view of an electronics module of the animal control unit of FIG. 1, showing solar cells mounted on an upper surface of the electronics module.

FIG. 2B is a bottom perspective view of the electronics module of FIG. 2A, showing a pair of electrodes mounted on an underside of the electronics module.

FIG. 3A is a top perspective view of a strip electrode, showing screw plates for attaching the electrode to the electronics module.

FIG. 3B is a bottom perspective view of the strip electrode of FIG. 3A, showing a contoured outer surface for contacting skin of an animal.

FIG. 3C is a bottom perspective view of the strip electrode of FIG. 3A mounted to the underside of the electronics module of FIG. 2A.

FIG. 3D is a front perspective view of the strip electrode of FIG. 3A mounted to the underside of the electronics module of FIG. 2A.

FIG. 3E is a bottom perspective view of an alternative strip electrode, including a continuous ridge protruding from the contoured outer surface mounted to the underside of the electronics module of FIG. 2A.

FIG. 3F is a front perspective view of the strip electrode of FIG. 3E mounted to the underside of the electronics module of FIG. 2A.

FIG. 3G is a bottom perspective view of an alternative strip electrode, including a series of discontinuous ridges protruding from the contoured outer surface mounted to the underside of the electronics module of FIG. 2A.

FIG. 3H is a front perspective view of the strip electrode of FIG. 3G mounted to the underside of the electronics module of FIG. 2A.

FIG. 4A is a side perspective view of a knob electrode, showing a thread for mounting the electrode to the electronics module.

FIG. 4B is a side perspective view of the knob electrode of FIG. 4A, showing a flat for aiding tightening and removing the electrode from the electronics module.

FIG. 4C is a bottom perspective view of a pair of knob electrodes of FIG. 4A mounted to the underside of the electronics module of FIG. 2A.

FIG. 4D is a front perspective view of a pair of knob electrodes of FIG. 4A mounted to the underside of the electronics module of FIG. 2A.

FIG. 5A is a bottom perspective view of a combination electrode, comprising a knob portion and a bar portion, mounted to the underside of the electronics module of FIG. 2A.

FIG. 5B is a front perspective view of the combination electrode of FIG. 5A mounted to the underside of the electronics module of FIG. 2A.

FIG. 5C is a bottom perspective view of a combination electrode, comprising a knob portion and a bar portion having an undulating profile, mounted to the underside of the electronics module of FIG. 2A.

FIG. 5D is a front perspective view of the combination electrode of FIG. 5B mounted to the underside of the electronics module of FIG. 2A.

FIG. 6A is a perspective view of a collar of the animal control unit of FIG. 1, showing a pair of buckles providing a means to adjust the length of the collar, and a biasing means attached to a strap of the collar.

FIG. 6B is a front view of the biasing means of FIG. 6A, showing a U-shaped wire through which, a strap of the collar is inserted.

FIG. 6C is a photograph of the animal control unit of FIG. 6A fitted to a cow, showing respective degrees of freedom of the biasing means in the X and Y directions.

FIG. 7A is a perspective view of a collar of the animal control unit of FIG. 1, showing an alternative biasing means fitted to the collar.

FIG. 7B is a photograph of the animal control unit of FIG. 7B fitted to a cow, showing the respective degree of freedom of the alternative biasing means in the Y direction.

FIG. 8A is a perspective view of a collar of the animal control unit of FIG. 1, showing an alternative combination biasing means attached to the collar.

FIG. 8B is a photograph of the animal control unit of FIG. 7B fitted to a cow, the combination biasing means being restricted in the X and Y directions.

FIG. 9A is a top perspective view of the buckle of FIG. 6A, in a closed configuration.

FIG. 9B is a bottom perspective view of the buckle of FIG. 9A, illustrating a latch and clasp portion.

FIG. 9C is a perspective view of the latch of FIG. 9B, showing a toothed portion.

FIG. 9D is a perspective view of the clasp of FIG. 9B, showing a corrugated portion.

FIG. 10 is a perspective view of an alternative embodiment of the animal control unit, showing a single buckle providing a means to adjust the length of the collar, and a biasing means attached to a collar comprising a single strap.

FIG. 11A is a top perspective view of a clip providing an attachment means of the collar of FIG. 10, with a buckle providing a means to adjust the length of the collar.

FIG. 11B is a perspective view of the buckle and clip of FIG. 11A, illustrating a latch of the buckle in an open position.

FIG. 11C is a perspective view of the buckle and clip of FIG. 11A, illustrating a latch of the buckle in a closed position.

### DESCRIPTION OF EMBODIMENTS

In the following detailed description, reference is made to accompanying drawings which form a part of the detailed description. It will be readily understood that the aspects of the present disclosure, as generally described herein and illustrated in the drawings may be arranged, substituted, combined, separated and designed in a wide variety of different configurations, all of which are contemplated in this disclosure.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the example methods and materials are described herein.

The embodiment of the animal control unit 1 shown in the figures is suitable for being worn by livestock such as cattle, sheep, buffalo, camel, and deer. It is understood, however, that other implementations or modifications can be made without departing from the spirit and scope of the specification.

In general terms, the animal control unit 1 shown in the figures provides an apparatus for implementing a virtual fencing system (also known as a “virtual herding system”, “virtual shepherding system”, “virtual boundary”, or “virtual paddock system”). As is described in more detail below, the animal control unit 1 comprises a collar 2 configured to be fitted around the neck of an animal such as cattle, an electronics module 3 and a biasing means 4 attached to the collar 2. The electronics module 3 includes two or more electrodes 6 and typically an antenna or antennae (not shown). Electrodes 6 are configured to deliver an electrical stimulus to the animal should it approach a boundary defined by the virtual fence. Biasing means 4 is configured to provide a self-righting action to facilitate substantially consistent alignment of the animal control unit 1—typically, it is desired that the electronics module 3, or at least, solar cells 11 coupled to the electronics module 3, remain substantially atop the neck of the animal. This advantageously increases the likelihood that the solar cells 11 remain facing in a consistent vertical direction—for example, in a general direction of the sun.

The animal control unit 1 is suitable for use within a virtual fencing system, such as described in PCT publication no. WO 2018/152593 A1 by the present Applicant—the entire disclosure of that publication is incorporated herein by reference. The animal control unit 1 can also embody the features described in PCT publication no. WO 2020/047581 A1, again by the present Applicant—the entire disclosure of that publication is also incorporated herein by reference.

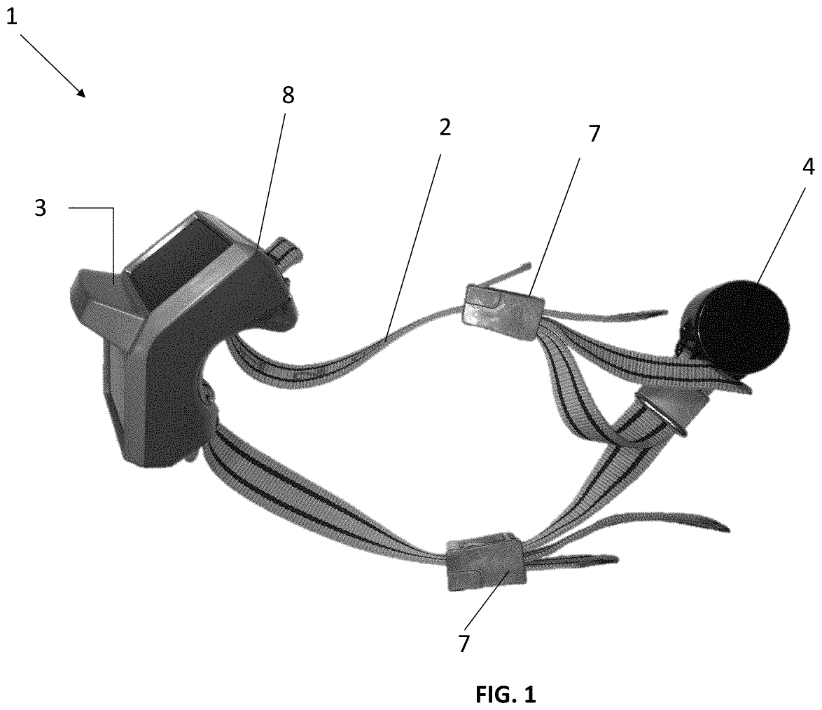

FIG. 1 shows an embodiment of the animal control unit 1, configured to be worn by an animal, in the example shown, the animal being large livestock such as cattle. Opposing ends of collar 2 are releasably attached to electronics module 3. Biasing means 4 is a counterweight and is positioned centrally (or at least between the opposing ends of the collar 2, preferably substantially centrally) along a length of the collar 2. When fitted to cattle, electronics module 3 sits atop the neck of the animal, and the biasing means 4 hangs below the neck of the animal. Buckles 7 provide a means for adjusting the length of collar 2. Buckles 7 provide a continuous method of adjustment, enabling the animal control unit 1 to be fitted to cattle of varying size. It may be preferred that the animal control unit 1, when in use, is fitted tightly enough to ensure that the animal control unit 1 remains around the neck of the animal while providing enough play to allow for the self-righting action of the biasing means 4. Natural movement of the animal may advantageously assist with alignment of the animal control unit 1. The animal control unit 1 typically should be fitted with enough slack to avoid, or reduce the risk of, lesions and other injuries to the animal.

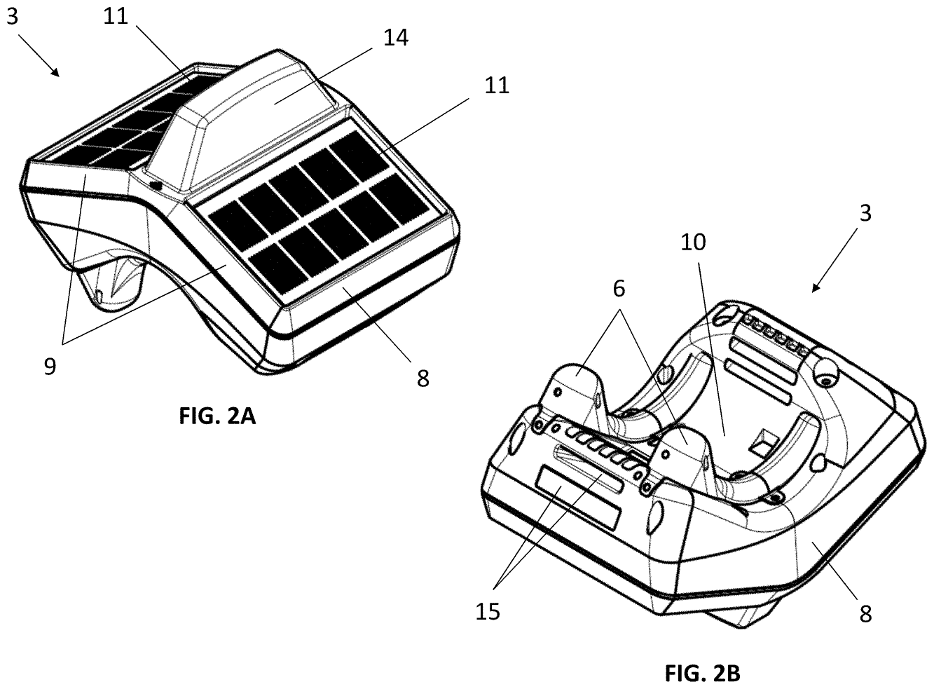

Components of the electronics module 3 are contained within a housing 8. As illustrated in FIG. 2A, the housing 8 can be substantially V-shaped. The housing 8 predominantly comprises at least one slanted surface 9, for example as shown a pair of adjacent slanted surfaces 9, and a concave base surface 10. The housing 8 is made of a resilient material. This material can be a polymer. The material may be a toughened plastic. Preferably, the material may be relatively lightweight and UV and chemically resistant.

One or more outward facing solar cells 11 are disposed on an exterior portion of the one or more upward facing slanted surfaces 9 of the housing 8. In the embodiment shown, two outward facing solar cells 11 are provided, one on each of two slanted surfaces 9. To maximise a surface area of the solar cells 11, the solar cells can extend substantially across the slanted surfaces of the housing 8. A slant angle of the slanted surface 9 is chosen to maximise light absorption by the solar cells 11. The slant angle is selected to provide an optimal incidence angle for the array of solar cells 11 to absorb sun rays when the animal control unit 1 is fitted to the animal. The optimal incidence angle typically provides an optimal (or at least improved) average incidence of sunlight onto the one or more solar cells 11 throughout the day. This advantageously maximises the power generated by the array of solar cells 11, providing a renewable source of power to other components of the electronics module 3 for ensuring operation of the animal control unit 1. Advantageously, due to the action of the biasing means 4, the slant angle can be selected on the basis that the animal control unit 1 will generally be consistently aligned—therefore, the one or more solar cells 11 will generally be facing in a consistent direction relative to the animal's neck.

The slant angle for slanted surfaces 9 can be selected based on one or more factors. For example, latitude and sunlight hours associated with a geographic location within which the animal control unit is to be used can affect the optimal incidence angle for solar cells. Similarly, known and observed animal behavioural patterns, such as sustained periods of rumination or grazing, associated with the animal holding its neck in upward or downward poses respectively, can affect the slant angle of the slanted surfaces 9 which provides the optimal incidence angle to the solar cells 11. The optimal angle of the slanted surfaces 9 can therefore differ depending on the size and type of animal upon which the animal control unit 1 is fitted. As such, it is understood that the positioning of the solar cells 11, in an upward facing position on the housing 8 at a predetermined slant angle, is an advantageous feature of the embodiment.

The slant angle for the slanted surfaces 9 can be selected based on the result of a calculation based on a selected model. For example, a model may account for one or more of the factors discussed above, or any other suitable factor. The calculation can be based on known methods, such as a Monte Carlo simulation of the facing direction of the animals and the neck position of the animals during predetermined times of the day. One model simulates, based on a Monte Carlo approach, the average incidence onto the one or more solar cells 11 according to a particular slant angle, a random facing direction of the animal, an observed probability of the animal's head being lowered to graze or not lowered when not grazing (for example, the probability depending on the time of the day), and a known solar angle and sunlight hours for a particular latitude. Based on the application of the model to a variety of combinations of number of solar cells 11 and slant angle, an optimal (or at least, improved) number of solar cells 11 and slant angle can be selected.

In an advantageous embodiment, at least two slanted surfaces 9 are provided wherein the slanted surfaces 9 are substantially symmetrically arranged on the housing 8—for example, as shown, two slanted surfaces 9 may be symmetrically arranged about an axis of the housing 8 substantially aligned with a direction of the neck of the animal. However, it is envisaged that in some implementations, it may be advantageous to have one or more solar cells 11 substantially upward facing—that is, on a slanted surface 9 having zero slant angle. Such an implementation may be appropriate at a latitude close to the equator.

Within a water-tight interior of the housing 8, electrical components including a GPS module having an antenna (not shown), a radio module having an antenna (not shown) and a processor (not shown) are accommodated. The GPS module is configured to determine positional data related to the location of the animal control unit 1, and therefore, the location of the animal wearing the animal control unit 1. In the embodiment shown in the figures, the antennae are located within a trapezoidal fin-like portion 14 of the housing 8, extending from a vertex between the slanted surfaces 9. Whilst the antennae can be located anywhere within the housing 8, this preferred arrangement may be beneficial as the antennae are located at a top-most portion of the animal control unit 1. This positioning can provide superior signal and reception strength for the antenna, for example whilst also minimising interference and noise from solar cells 11.

In reference to FIG. 2B, the concave base surface 10 is contoured to fit snugly along the natural recesses of the back and spine of the animal wearing the control unit 1. Rectangular slits 15 are disposed on opposing sides of the housing 8, close to a vertex between the slanted surfaces 9 and the concave base 10. The slits 15 are sized and shaped to receive the opposing ends of the collar 2, releasably attaching the collar 2 to the electronics module 3. As illustrated, the slits 15 are formed as a pair of rectangular slits. An advantage of this placement of the slits 15 (close to the vertex between surfaces 9 and 10), is that in use, the collar 2 is in contact with the skin of the animal wearing the collar 2 until close to the point where the collar 2 enters the slits 15.

A pair of electrodes 6 are positioned on the concave base surface 10 of the housing 8. The electrodes 6 are configured to provide a stimulus to the animal wearing the collar 2, if the animal strays outside of a predetermined region. The processor compares data received via the GPS module, related to the current position of the animal, and compares this data to pre-stored values accessible to the processor. As such, the animal control unit 1 operates within a virtual fencing system. It is understood that the electrodes 6 positioned on the housing 8 may take many forms, and that the number of electrodes may be more than 2, or only 1 (where a second electrode is separate to the housing 8). In certain embodiments, the housing 8 of the electronics module 3 can also act as an audio source, for example with an exciter (not shown) coupled to an interior surface of the housing providing acoustic vibrations. Such an arrangement may be advantageous in that it provides a more robust housing 8 than would otherwise be allowed in the fitment of a typical loudspeaker within the housing 8, as it reduces or eliminates the need for having holes in the housing 8 to allow passage of the required aural stimulus at sufficient volumes. However, in another example, a standard speaker is located within the housing 8 to act as the audio source. Generally, the resultant sound from the audio source can act as an audible stimulus. As described in, for example, U.S. Pat. No. 9,107,395, the animal may learn to respond to the audible stimulus, thereby minimising the use of an electrical stimulus.

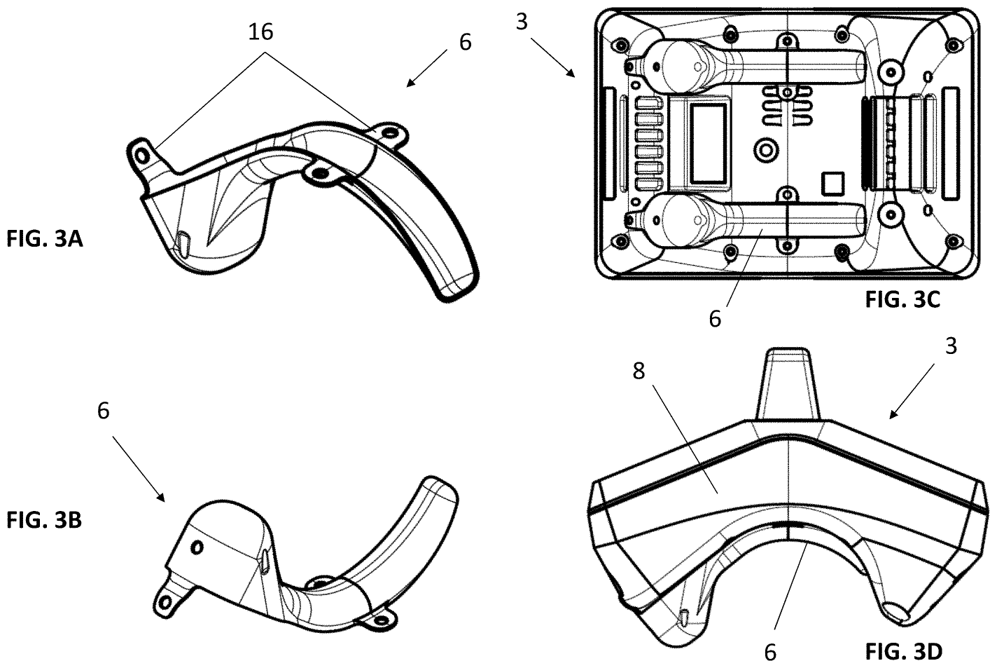

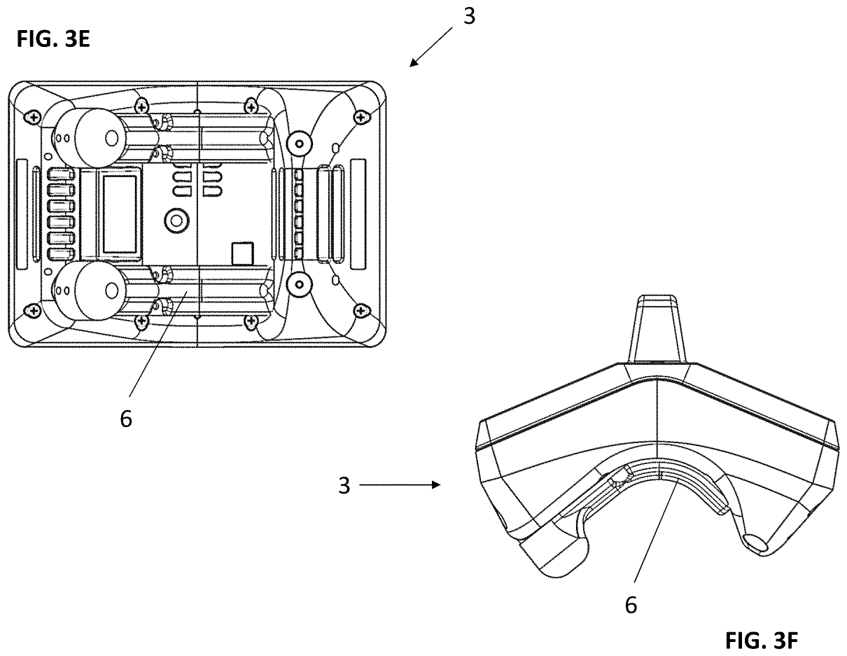

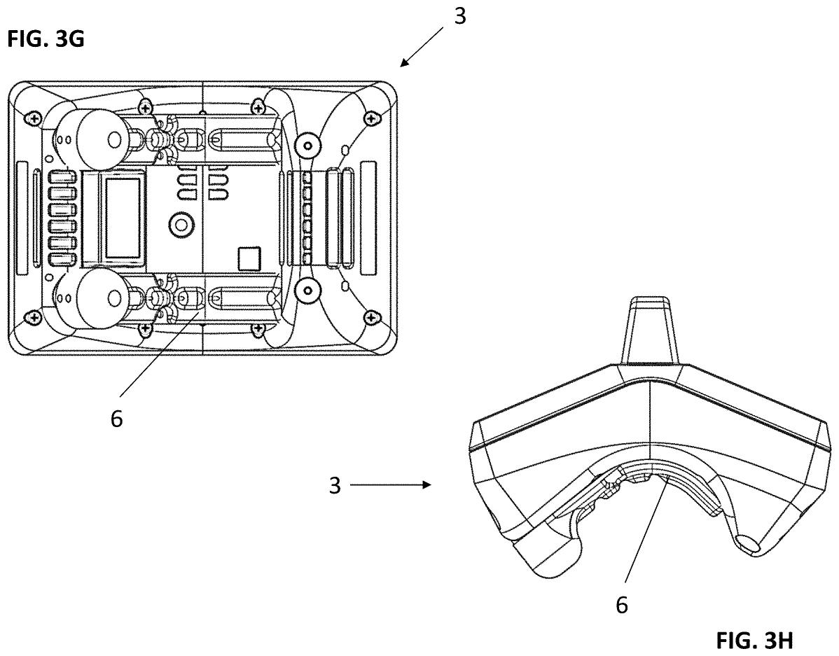

FIGS. 3A-3H illustrate a preferred embodiment of the electrodes 6. The electrodes 6 are made from a conductive material, for example stainless steel. At least one electrode 6 is a strip electrode. In the embodiment shown, both electrodes 6 are strip electrodes—with each being in the shape of an arch. The electrodes 6 can be shaped to ergonomically sit within natural contours within the neck of the animal. For example, the strip electrodes 6 can include a ridge that runs substantially along a length of the arch. The ridge may comprise a single continuous tubular body (e.g. as per FIGS. 3E-3F) or alternatively, a series of discrete protrusions (e.g. as per FIGS. 3G-3H). An advantage of these shapes may be that the likelihood of at least a portion of the surface area of the electrode 6 being in contact with the surface of the animal is maximised, providing for a consistent and predictable delivery of stimulus. This may reduce the chance of injury and discomfort to the animal that may occur due to concentrations of transmissions of a conductive charge or stimulus. Additionally, the ergonomic shaping of the strip electrodes 6 may reduce the required tightness of the collar 2 while ensuring that the electrodes remain predominantly in contact with the skin of the animal, maximising the effectiveness of the aversive stimulus whilst maintaining animal comfort and wellbeing. That is, such strip electrodes 6 can advantageously avoid, or at least reduce, instances wherein the electrode 6 is not in contact with the surface of the animal due to movement of the animal control unit 1. Consistent delivery and application of pulse is required for successfully training the animal a desired learned behaviour. This may be particularly advantageous for animals of narrow neck profile.

The electrodes 6 are secured to the curved base surface 10 of the housing 8 via screw plates 16, through which a screw is inserted and received within similarly sized tapped holes 17 positioned on the concave surface 10. The tapped holes 17 provide a means of interchangeably fitting different shaped and sized electrodes 6, to best suit the size and shape of the animal wearing the animal control unit 1. Further, this method of attachment advantageously maintains a smooth outer surface to the electrodes 6, which may minimise the likelihood of the electrodes 6 and connected housing 8 becoming snagged on environmental obstacles such as fences and branches.

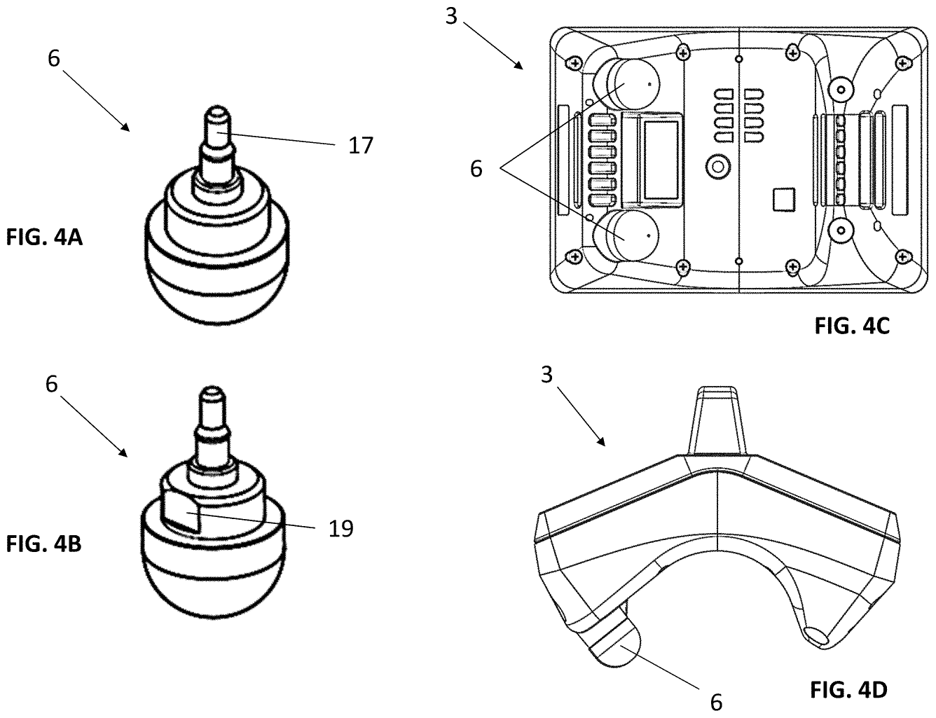

A further embodiment of the electrodes 6 is shown in FIGS. 4A-4D. In this embodiment, at least one electrode 6 is a knob-shaped electrode (in the embodiment shown, there are two knob-shaped electrodes 6). The knob-shaped electrodes 6 are made of a conductive material. The knob-shaped electrodes 6 have a threaded shaft 18 which is received within a similarly sized tapped holes 17 on the concave surface 10 of the housing 8. A flat 19 on the threaded shaft provides a means for tightening and gripping the electrode using a conventional wrench or the like. A knob-shaped electrode 6 may provide an advantage when used with animals with relatively thick wool or hair, such as sheep's wool.

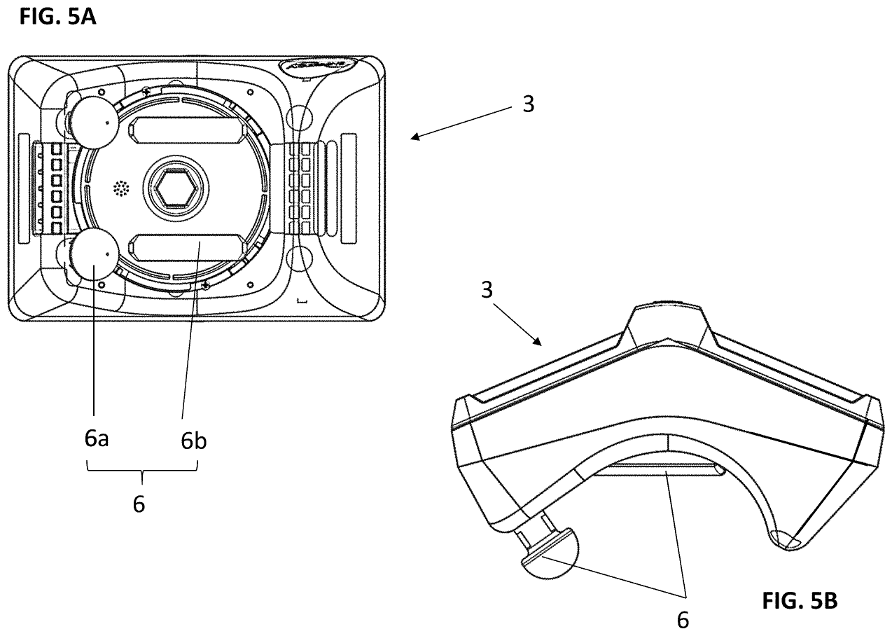

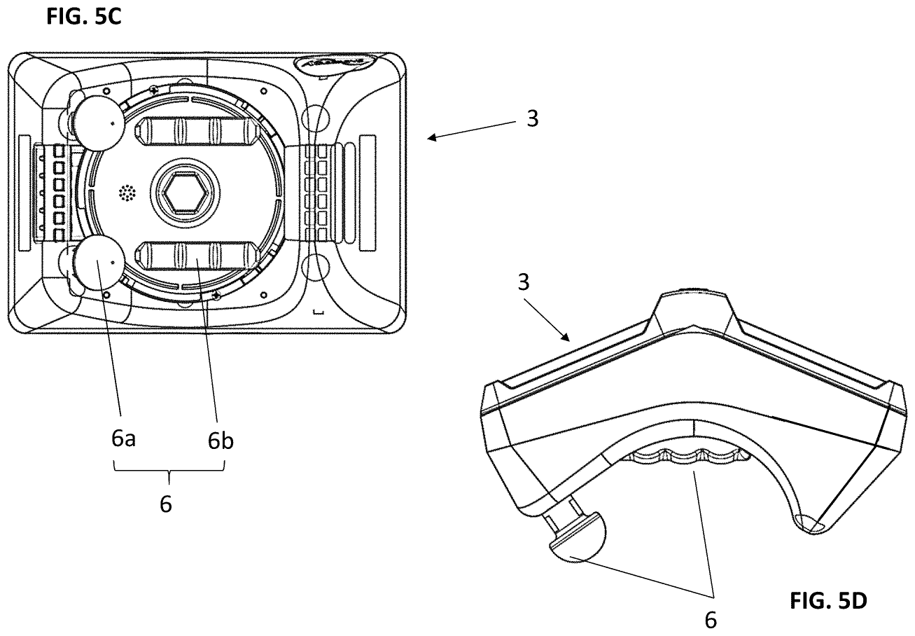

Yet a further embodiment of the electrodes 6 is shown in FIGS. 5A-5D. In this embodiment, at least one electrode 6 is a combination electrode (in the embodiment shown, there are two combination electrodes 6). The combination electrodes comprise a knob-shaped portion 6a and a spatially separated bar portion 6b. The knob 6a and bar 6b portions are electrically coupled to one another. As illustrated, the knob portions 6a are similar to those described in respect to the knob electrodes of FIGS. 4A-4C. The bar portion 6b can have a smooth outer surface (for example, as shown in FIG. 5C). In an alternative, the bar portion can have an undulating outer surface (for example, as shown in FIG. 5D). The bar portion 6b of the combination electrode 6 may provide an advantage in providing additional contact area between the electrode 6 and the skin of the animal, to that offered by the knob portion 6a if used alone.

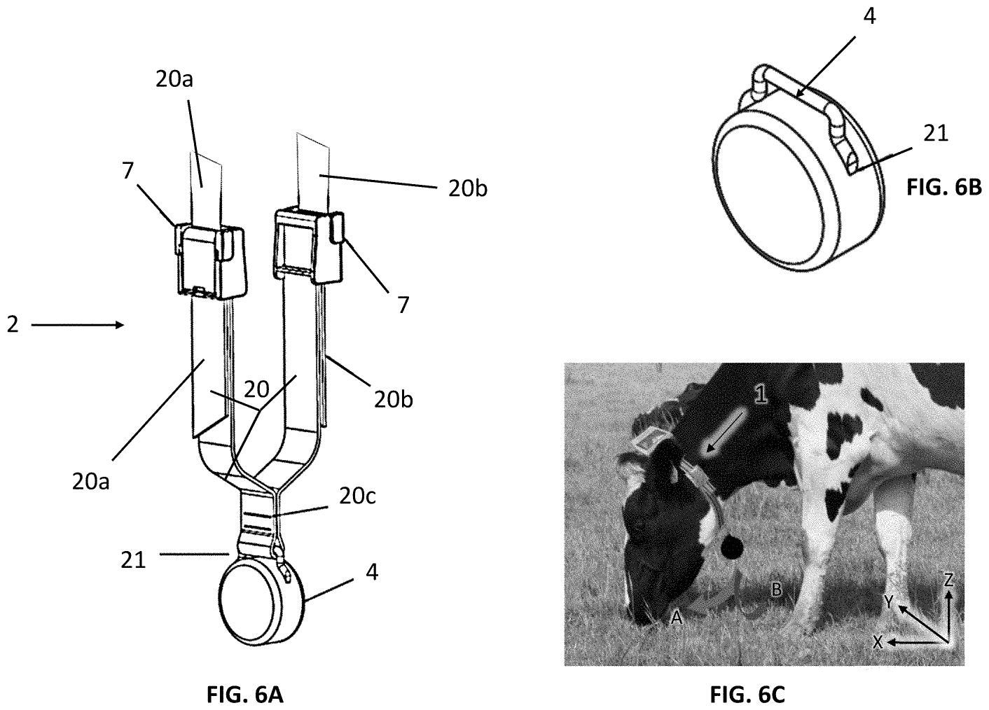

FIG. 6A is a representation of one embodiment of the collar 2. As shown, collar 2 comprises of three straps 20. The straps 20 are resistant to substantial stretching. The straps 20 can be made of a nylon material or similar. A first 20a and a second 20b of the straps 20 are attached at one end to the electronics module 3 through the slits 15. Opposing ends of the first and second straps 20a, 20b, are received and constrained within a pair of buckles 7. The length of the collar 2 can thus be adjusted by releasing buckles 7, and sliding the ends of straps 20a, 20b respectively in either a forward or rearward direction through the buckles 7. A third strap 20c completes the collar 2. Opposing ends of the third strap 20c are received within each of the buckles 7, and provide a means for adjusting the length of the collar 2. Disposed mid-way along strap 20c, and thus at a centre point of the collar 2 when being worn by the animal, is biasing means 4. As used herein, the term “biasing means” refers to a counterweight configured to provide a self-righting force in response to gravitational movement of the electronics module 3.

Biasing means 4, in an embodiment shown in FIG. 6B, is a circular medallion-like counterweight. Other possible shapes include substantially spherical, cylindrical, elliptical, or any other suitable shape (for example, a shape can be selected to provide a desired mass distribution). The counterweight 4 can include a high-density metal such as mild steel. The counterweight 5 should be heavier than the electronics module 3—for example, a ratio of the mass of the counterweight 4 to mass of the electronics module 3 of at least 1.2 may be suitable, and a higher ratio, such as 1.5, will provide a stronger self-right force, thereby enabling the required operation of the biasing means 4. In one example, the counterweight 4 mass is 1.5 kg, being twice the mass of the electronics module 3. More generally, the selected mass of the counterweight should be sufficient to enable the counterweight 4 to provide a self-righting force to the electronics module 3 when worn by an animal. As such, during movement of the animal's neck or, for example, running or other movements, the electronics module 3 is biased to remain atop the animal's neck. This advantageously provides optimal positioning for the solar cells 11 and GPS module, as well as the electrodes 6 for contacting the animal, and also assists in ensuring maximum antenna reception signal strength and exposure. It is understood, however, that dependent on the breed and size of animal, and the size and weight of the electronics module 3, the counterweight 4 can weigh more or less than 1.5 kg. Counterweight 4 can be enclosed within a water-proof and soft-finish coating. The coating can be a polymer coating. The coating can be a powder coating. The counterweight 4, for example via its enclosure or coating, can be shaped to exclude sharp edges (at least those edges likely to contact the animal), to reduce or minimise the risk of abrasions or discomfort for the animal. The coating also ensures that no rust or similar affects the counterweight 4. Counterweight 4 is attached to the collar 2 through a U-shaped wire 21, both ends of which are rigidly attached to the counterweight 4. Collar 2 is thus threaded through an aperture created between the counterweight 4 and the wire 21. It is also contemplated that the counterweight can alternatively be a be a sack-like counterweight, in which pellet like masses are held within a soft bag. An advantage of such an embodiment is that any contact with an animal is spread over a larger area of contact, thereby dissipating the impact forces.

As shown in FIG. 6C, an embodiment of the animal control unit 1 is designed to be fitted around the neck of a bovine animal. The attachment of counterweight 4 to the collar 2 embodies the counterweight 4 with a necessary degree of play in a longitudinal X direction (along a length of the animal) and a lateral Y direction (across a width of the animal). This freedom of movement provides a pendulum-like swinging motion to the counterweight 4 during movement of the animal, in order to facilitate the self-righting force. Arrows A and B indicate the degrees of freedom in the X and Y direction respectively.

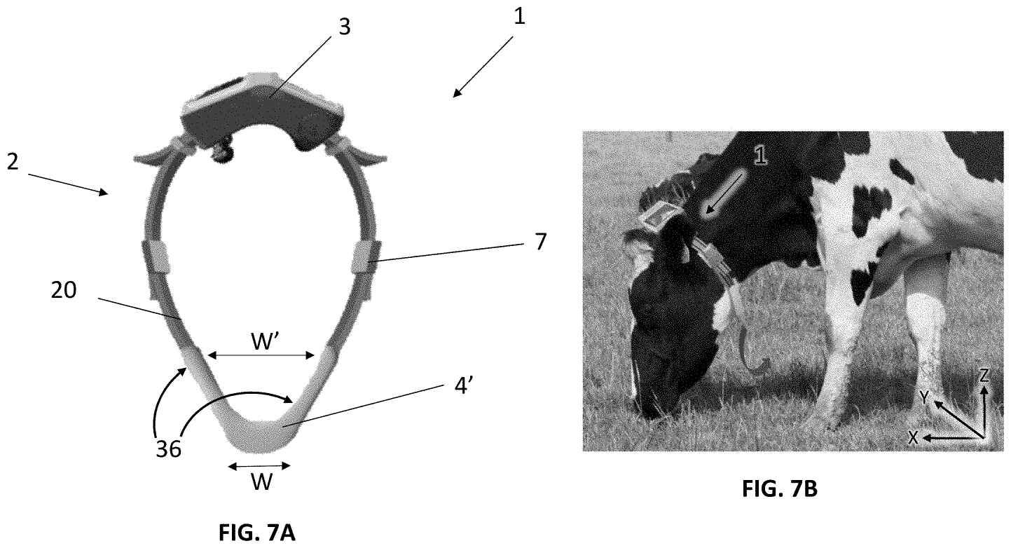

In an alternative embodiment shown in FIG. 7A, a U or V-shaped biasing means 4′ is fitted to the collar 2. The biasing means 4′ replaces the free-swinging biasing means 4 whilst being configured to provide the same self-righting force to the electronics module 3. The biasing means 4′ comprises a pair of arms 36 that are attached to the straps 20 of the collar 2, such that in use the biasing means 4′ fits snugly under the neck of the animal. The shape of the counterweight 4′ can be selected based on the particular breed of animal or can be provided as a generic shape suitable for a range of breeds of animals. The arms 36 each extend along the strap 20 towards the electronics module 3. A distance W across the biasing means 4′ where the arms 36 meet is less than a distance W′ between the arms 36 where they attach to the strap 20, providing the distinctive U or V shape. The arms 36 (thus serve as distributed weights, spreading the mass of the biasing means 4′ along the collar 2 which can also advantageously reduce the rotational inertia of the counterweight 4′ with respect to an effective pivot point on the collar 2, which can advantageously reduce the stopping force exerted by the animal upon impact by the counterweight 4′ and correspondingly reduce the risk of injury. It is also contemplated that the biasing means 4′ may be integrally formed with the collar 2, through distributed weights that are stitched thereto or otherwise encapsulated therein. In such an embodiment, the distributed weights are shaped to follow a contour of the underside of the neck of the animal. Accordingly, it is noted that the straps 20 have a sufficient width to allow the biasing means 4′ to be supported thereon in a distributed manner (i.e. along a length of the neck of the animal). It is typically preferred that the collar 2 with such biasing means 4′ is affixed to the animal with sufficient free movement to ensure that the collar 2 does not permanently rest at the same location on the animal, which can lead to injury.

As shown in FIG. 7B, the fit and shape of the biasing means 4′ reduces a forward trajectory of the associated swinging motion of the biasing means 4′ in the X or longitudinal direction, whilst still allowing for a side-to-side pendulum, motion in the Y or lateral direction. Specifically, the portion of the collar within which the distributed weights are formed or attached will be inherently less flexible than the remainder of the collar 2 and preferably substantially retain its shape in use. In this way the less flexible portion of the collar, acting as the counterweight 4′, will resist swinging of the collar 2 in the longitudinal directions by not easily rotating about the underside of the neck of the animal. The reduction in the forward trajectory of the biasing means 4′ may result in the biasing means 4′ remaining substantially free of movement in the longitudinal direction. Because the forward trajectory of the biasing means 4′ is restrained (i.e. reduced or eliminated), a tendency of the biasing means to potentially strike an underside of the chin of the animal is reduced and preferably eliminated. This embodiment may be particularly advantageous for animals with an inherent erratic grazing pattern, characterised by quick, short aggressive neck movements.

The counterweight 4′ can be shaped such that, in situations where it does strike the animal (despite the reduced movement of the counterweight 4′), it tends to strike with a relatively large surface area, which can advantageously spread the force of impact and thereby reduce again the risk of injury. The counterweight 4′ can include a tapered lower portion which may advantageously reduce the risk of this lower portion (which can have a higher angular velocity) striking the animal.

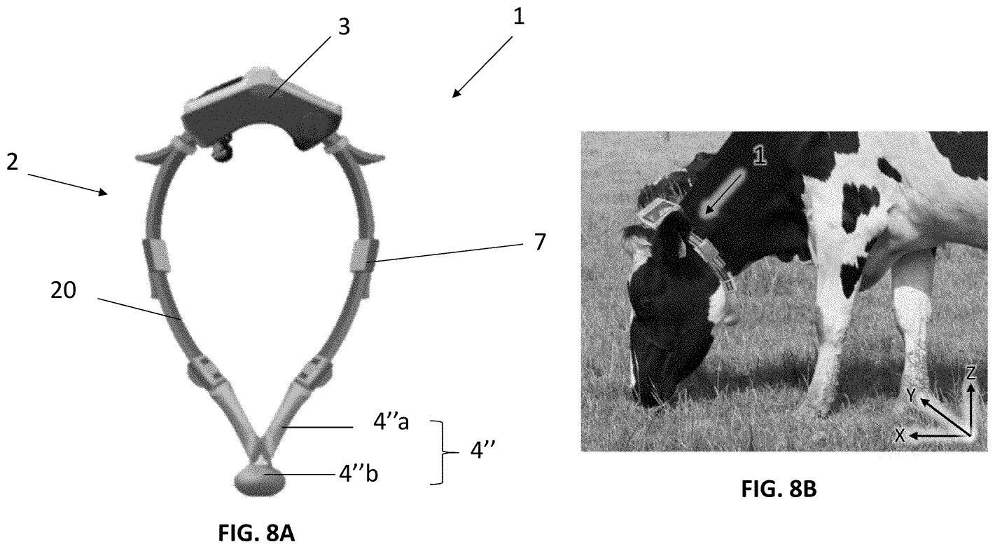

In another alternative embodiment shown in FIG. 8A, a combination biasing means 4″ is fitted to the collar 2. The combination biasing means 4″ comprises distributed weights 4″ a and a central weight 4″b. The distributed weights 4″a are similar to the arms 36 of the V-shaped biasing means 4′, in that they may be integrally formed within the collar 2, and/or stitched thereto or encapsulated therein. The distributed weights 4″ allow the central weight 4″b to be of a reduced mass when compared to counterweight 4. The central weight 4″b can be a medallion-like counterweight or a sack-like counterweight, in which pellet like masses are held within a soft bag, as discussed in relation to biasing means 4.

As shown in FIG. 8B, the presence of the distributed strap weights 4″a reduces the forward trajectory of the associated swinging motion of the biasing means 4″ in the X or longitudinal direction, whilst the presence of the counterweight 4″b reduces the side-to-side motion of the biasing means 4″ in the Y or lateral direction. In this way, the overall pendulum motion of the biasing means 4″ is reduced or eliminated entirely, whilst still providing a degree of play between the collar 2 and the neck of the animal. This embodiment can advantageously provide a particularly stable solution that maximises animal comfort without negatively affecting the self-righting ability of the animal control unit 1.

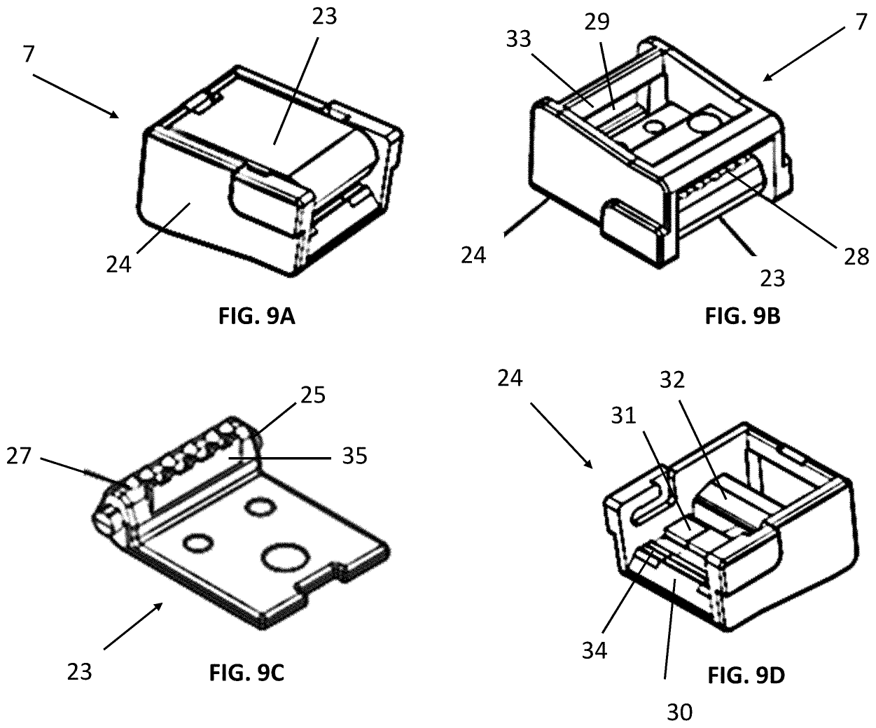

FIGS. 9A-9D show an embodiment of the buckles 7. Buckles 7 will be discussed in the following section in reference to one of the pair of buckles 7, into which the first strap 20a is inserted. It is thus understood that the following discussion is equally applicable to the second of the pair of buckles 7, into which the second strap 20b is inserted. For the discussion below, the buckle 7 will be discussed as having a front end and a rear end. The rear end of the buckle 7 is understood to be the end closest to the electronics module 3.

Buckle 7 is comprised of a latch 23 and a clasp 24. Buckle 7 is arranged such that in a closed, or locked configuration, engagement between the latch 23 and clasp 24 prevents movement of strap 20a, hence fixing the length of the collar 2.

Latch 23 comprises a square flat plate, perpendicularly attached at one end to the body of a cylindrical shaft 25.

Clasp 24 is rectangular and includes four cross members 30,31,32,33 disposed between the rear end and front end, parallel to the cylindrical body 25 of the latch 23. The arrangement of the cross-members 30,31,32 and 33 are such that the first cross member 30 is located rear-most in the buckle 7, and the fourth cross member 33 is the forward most, in a direction of movement from the rear end to the front end of the buckle 7.

Latch 23 is pivotably attached to clasp 24, enabling the latch 23 to be lifted into an open position, or pushed down onto clasp 24 to a locked position. In an open, or unlocked configuration, the arrangement of the buckle 7 is such that the length of the collar 2 can be adjusted via pulling either straps 20a or 20c through the buckle in a forward or rearward direction, depending on the sizing adjustment required.

A friction means 26 provides a mechanism through which straps 20 are securely held within the buckle 7. The friction means 26, in the illustrated embodiment includes a primary toothed portion 27. The primary toothed portion 27 is a row of cone shaped teeth, and taper to a point. The primary toothed portion 27 is disposed on the cylindrical shaft 25 of latch 23. Teeth of the primary toothed portion 27 engage against first strap 20a, friction generated therebetween securely holding the first strap 20a in position, restricting movement. As such, it is understood that the buckles 7 provide continuous adjustment, limited only by the lengths of straps 20a and 20c. This is advantageous when compared to other fastening mechanisms such as holed belts, which feature much more finite adjustment levels. The friction means 26 is configured such that a force above a threshold level can overcome the friction means 26, such that the collar 2 can be released. The threshold level can be determined dependent on the animal for which the animal control unit 1 is to be fitted. For example, a force of approximately 100 kgf may be suitable for cattle. As such, if the animal was to become entangled, application of a pulling force (in this example, exceeding 100 kgf) would result in the collar releasing. This feature may advantageously reduce the likelihood of injury or distress caused upon the animal in such an instance.

The first toothed portion 27 extends axially along the cylindrical shaft 25. The first toothed portion 27 does not extend around the full circumference of the cylindrical shaft 25. As such, the first toothed portion 27 provides both an engaged, or closed configuration, and a non-engaged, or open configuration.

The friction means 26 of the latch 23 includes a second toothed portion 35. The first toothed portion 27 and second toothed portion 35 are arranged such that when viewed in isolation, the latch 23 appears to have a first row of teeth (first toothed portion 27) and a second row of teeth (second toothed portion 35). The second toothed portion 35 comprises a flat face extending tangentially from the cylindrical portion 25, topped with rounded blunted teeth. With the buckle 7 in a closed configuration, the second toothed portion 35 engages against the third strap 20c. This engagement can provide a ratchet-like mechanism, such that the collar 2 can be tightened by pulling in a downwards direction on either of the free end of the third strap 20c, but not loosened. This can be advantageous, as it enables the collar 2 to be placed over the head of the animal, and then tightened in a simple manner, minimising the potential for distress for the animal. Another advantage of the attachment mechanism described may be that it can allow relatively quick fitting of the collar 2 to the animal—for example, this helps to reduce risk to the operator fitting the collar 2 due to animal movement from distress. For example, this may help to reduce risk to the operator as livestock, even when restrained individually in a crush and headbail, can still be very dangerous when distressed.

In the embodiment shown in the figures, the first strap 20a is fed through a rear aperture 28 of the buckle 7. The rear aperture 27 is formed between the cylindrical shaft 25 of the latch 23 and a first cross member 30 of the clasp 24. The first strap 20a is then threaded over a third crossmember 32, and out through a front aperture 29, at the opposing front end of the buckle 7. It is thus understood that in a closed configuration, teeth of the primary toothed portion 27 engage against the first strap 20a, such that it is secured against cross member 30. The first crossmember 30 includes a corrugated portion 34. The corrugated portion 34 is arranged such that in the closed configuration, the first strap 20a is also in frictional contact with the corrugated portion 34.

Concurrently, an end of the third strap 20c is fed through the front aperture 29 of the clasp 24. The front aperture 29 is defined by the gap between third cross member 23 and a fourth cross member 33. The third strap 20c is fed into the buckle through aperture 29, and wrapped around a second crossmember 31, and back out of the buckle 7 through the second aperture 29.

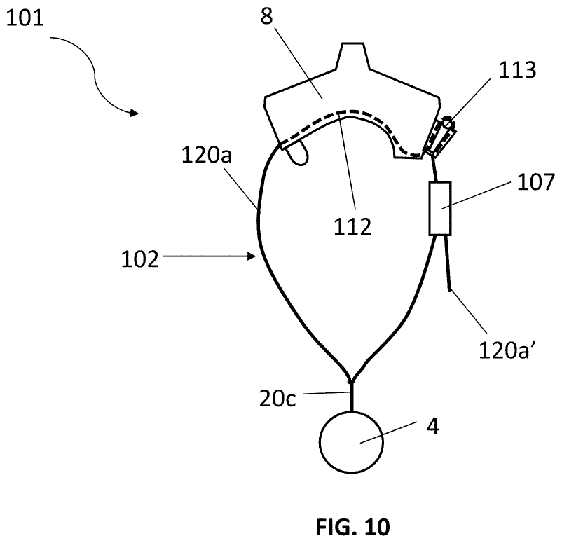

FIG. 10 is a representation of another embodiment of an animal control unit 101. As shown, collar 102 comprises of a single strap 120. Strap 120 runs through a slotted channel 112 that extends along the concave surface 10 from one side of the housing 8 to another. A retention device 113 is mounted onto a side of the housing 8, adjacent to an end of the slotted channel 112. The retention device 113 has a fixed and a released configuration. In the fixed configuration, the strap 120 is restrained from movement relative to the housing 8. As such, the retention device 113 enables the housing 8 to be secured on the collar 102 such that it is positioned substantially opposite to biasing means 4. The present embodiment may offer an advantage by providing a single point on the collar 102 required for adjustment when fitting to the animal.

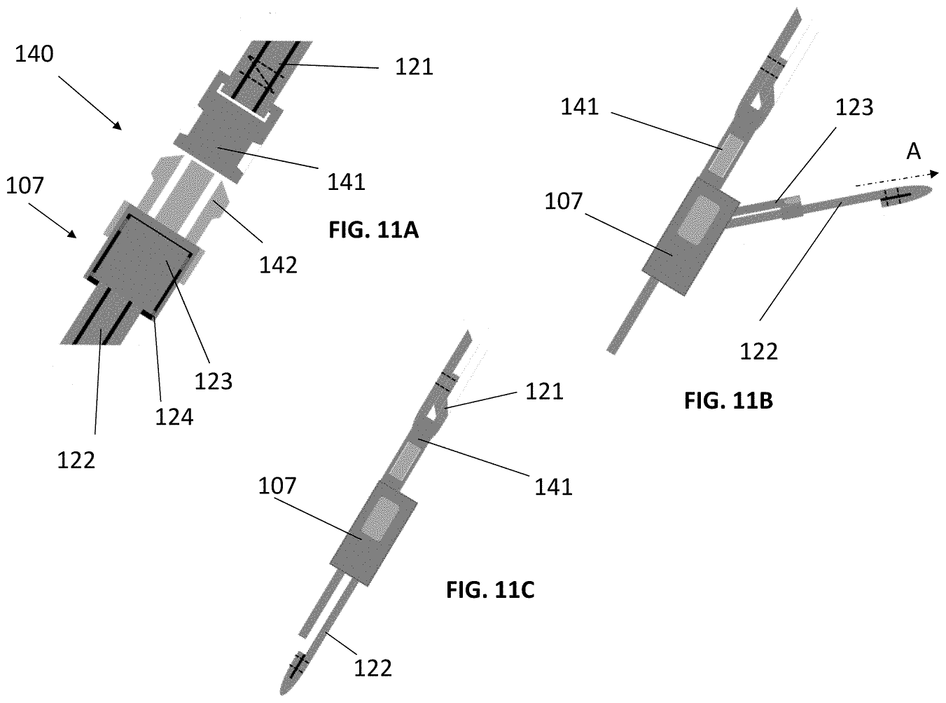

FIGS. 11A-11C illustrate an adjustment means by which the collar 102 can be secured around the neck of an animal, and its length altered. The adjustment means comprises a clip 140 and a buckle 107. As shown, buckle 107 is of similar type to buckle 7 previously described. Clip 140 can be a snap fit side-release clip.

A first end 121 of the strap 120 is attached to a first portion 141 of clip 140. An opposing second end 122 of the strap 120 is threaded through buckle 107. A second portion 142 of clip 140 is fixedly connected to the buckle 107.

As shown in FIG. 11A, the first portion 141 and the second portion 142 of the clip 140 are correspondingly configured to provide a quick release mechanism. Accordingly, an advantage of the clip 140 is that it may be simple and fast to secure the collar 102 around the neck of the animal. The buckle 107 comprises a latch 123 pivotably connected to a clasp 124. As shown in FIG. 11A, in an open position, the latch 123 is lifted away from clasp 124. The length of the collar 102 can be reduced by pulling the second end 122 of the strap 120 through the clasp 124, in a direction indicated by dotted arrow A. Likewise, the length of the collar 102 can be increased by pulling the second end 122 of the strap 120 in the opposite direction. Once the length of the collar 102 is adjusted to an appropriate length, an operator can push down the clasp 124 into the closed configuration, as shown in FIG. 11C, locking the length of the collar 102.

Several of the features of the animal control unit 1 provide an interworking advantage with each other. The shape of the housing 8, in addition to the self-righting force provided by the biasing means 4, may advantageously ensure that the electronics module 3 remains atop of the animal at all times. As such, the effectiveness of the array of solar cells 11 affixed to the housing 8, and hence the longevity of power supply to the electronics module 3, may be maximised by mounting the solar cells 11 at an upward facing slant angle. Furthermore, the profile of a strip electrode 6 may maximise the likelihood of a surface area of the electrode 6 being in contact with the skin of the animal, whilst also reducing the required tightness of the collar 2 needed to ensure that this contact is maintained. Reducing the required tightness of the collar 2 may advantageously improve the effectiveness of the biasing means 4, which utilises natural movement of an animal to provide the required self-righting action, whilst also providing a more comfortable fit for the animal. Also, accordingly, the strip electrode 6 shape may advantageously provide for the consistent delivery of an electrical stimulus required for a successful virtual fencing system.

1. An animal control unit comprising:
a housing comprising at least two electrodes and an electronics module configured to controllably deliver an electrical stimulus to an animal wearing the animal control unit via said at least two electrodes, wherein the housing is shaped such that it rests on the upper side of the animal's neck when in use;
a collar to which the housing is attached, the collar being configured for fitment around a neck of the animal to moveably retain the housing in a first position; and
a biasing means configured to provide a self-righting force such that the housing is biased towards the first position during movement, and
wherein at least one of said electrodes is a strip electrode comprising a strip portion shaped to rest along a natural contour of the animal's neck.

2. The animal control unit of claim 1, wherein the biasing means comprises a counterweight disposed along a length of the collar and configured to impart a self-righting force thereon, such that the housing is biased towards the first position during movement of the animal.

3. The animal control unit of claim 2, wherein the counterweight is substantially centrally located with respect to the collar.

4. The animal control unit of claim 2, wherein the counterweight has a mass at least 1.2 times the mass of the electronics module.

5. The animal control unit of claim 1, wherein the counterweight is adapted to have restrained movement in a lateral direction across a width of the animal during movement thereof.

6. The animal control unit of claim 2, wherein the counterweight includes a first weight that is distributed along a length of the collar.

7. The animal control unit of claim 6, wherein the first weight is integrally formed with the collar.

8. The animal control unit of claim 6, wherein the first weight is attached to the collar.

9. The animal control unit of claim 6, wherein the first weight is shaped to conform to an underside of the neck of the animal.

10. The animal control unit of claim 6, wherein the collar comprises at least one strap, the at least one strap having a width configured to distribute the first weight along a partial length of the neck of the animal.

11. The animal control unit of claim 3, wherein the counterweight includes a second weight that is located substantially centrally along a length of the collar, opposite the electronics module.

12. The animal control unit of claim 11, wherein the second weight is a metal medallion

13. The animal control unit of claim 12, wherein the metal medallion has a shape selected from one of: spherical, elliptical, and cylindrical.

14. The animal control unit of claim 12, wherein the second weight comprises a bag accommodating at least one of pellet-like forms or granular forms.

15. The animal control unit of claim 1, wherein, in the first position, a substantially central portion of the housing is located substantially at a top position on the neck of the animal.

16. The animal control unit of claim 1, wherein at least one electrode comprises a knob-shaped portion.

17. The animal control unit of claim 1, wherein at least one strip electrode comprises of two spatially separated portions.

18. The animal control unit of claim 17, wherein the collar comprises a plurality of elongate straps.

19. The animal control unit of claim 1, wherein the electronics module includes a solar powered electricity generator configured to provide electrical power for the animal control unit.

20. The animal control unit of claim 19, wherein the solar powered electricity generator comprises one or more solar cells are disposed on one or more slanted surfaces of the housing, wherein each slanted surface is outward facing.

21. The animal control unit of claim 20, wherein each slanted surface has a slant angle selected such as to maximise, or at least substantially maximise, an average received solar irradiation, wherein the average received solar irradiation is estimated based on at least one of: an expected latitude of use of the animal control unit; a modelled behaviour of the animal; and a number of solar cells.

22. The animal control unit of claim 1, wherein the collar has an adjustable length.

23. The animal control unit of claim 22, wherein the collar includes a buckle configured to enable adjustment of the length of the collar, wherein the buckle is configured to self-release upon application of a force exceeding a release threshold force.

24. The animal control unit of claim 23, wherein the release threshold force is approximately 100 kgf.

25. The animal control unit of claim 1, wherein the electronics module is further configured to controllably deliver an audible stimulus delivered by an exciter located within the housing.

26. The animal control unit of claim 1, wherein the electronics module is configured to deliver the electrical stimulus to the animal in response to the animal moving within a predetermined range of a predefined boundary.
